(19) United States
(12) Patent Application Publication
(10) Pub. No.: US 2005/0117568 A1
(43) Pub. Date: Jun. 2, 2005

(54) Speech communication system and communication apparatus for speech communication system, and telephone exchange apparatus

(75) Inventor: Kenichi Kitazawa, Hino-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/989,315

(22) Filed: Nov. 17, 2004

(30) Foreign Application Priority Data
Nov. 28, 2003 (JP) 2003-400889

(51) Int. Cl. H04L 12/28; H04L 12/56; H04L 12/66

(52) U.S. Cl. 370/352; 370/392; 370/401

(57) ABSTRACT

A telephone exchange apparatus includes a first interface to connect a circuit line being connected at least one of terminal and transmitting a corresponding speech signal, a plurality of second interfaces to connect a communication network including a plurality of speech channels allowing a transmission of a plurality of speech packets and at least one of control channel allowing a transmission of a plurality of control packets, a exchanger which connects between the first interface and at least one of the second interfaces according to a call setting request, and a controller which controls to forward an incoming call to another second interface, when the incoming call arrives through the control channel of the connection network and there exists no available communication channels, in each the second interfaces.

### CROSS-REFERENCE TO RELATED APPLICATIONS

This application is based upon and claims the benefit of priority from prior Japanese Patent Application No. 2003-400889, filed Nov. 28, 2003, the entire contents of which are incorporated herein by reference.

### BACKGROUND OF THE INVENTION

1. Field of the Invention

The present invention relates to a speech communication system for allowing speech communication to be made between telephone terminals via an IP (Internet Protocol) network for allowing the transmission of, for example, a speech packet and a communication apparatus for this speech communication system as well as a telephone exchange apparatus for improving an effective utilization rate of speech channels over the IP network.

2. Description of the Related Art

In recent years, a network telephone system (IP telephone system) has been beginning to be used which can interactively transmit/receive an image and speech as packet data in real-time over an IP network.

In this IP telephone system, IP telephone terminals are connected to the IP network and a packet network is connected to the public switched telephone network, such as analog telephone circuit lines or public network, through a gateway or a main apparatus, while, in the IP telephone terminals and gateway, a protocol conversion, data format conversion, etc., are made to allow speech communication to be made between the IP telephone terminals and between the IP telephone terminal and the public switched telephone network.

In this kind of system, an IP address is allocated to a plurality of IP network-connected interfaces in the main apparatus. For example, a caller on the IP network-connected telephone terminal (dial call node) dials in the node ID+extension number so as to make speech communication to a telephone set (connection destination node) on the main apparatus. In this case, the dial number is connected to a corresponding IP address and this is notified to the main apparatus of a connection destination. The main apparatus of the connection destination decides whether or not there is any available port. Here, if there is no available port, the caller on the dial call node takes a re-connection procedure with the use of another IP address. This takes a lot of time and labor from when the caller on the dial call node sends a dial call to until a communication link is established to a called party on the connection-destination terminal.

In order to solve foregoing problem, the following method has been proposed (For example, JPN PAT APPLN KOKAI PUBLICATION NO. 2003-169079). According to which, while monitoring the state of each interface through a signaling (call controller) section, an incoming call is received.

In the above-mentioned method, the states of a plurality of interfaces are monitored at all times and an incoming call is received through an available interface under a signaling section, so that a greater processing burden is exerted on the signaling section. It is, therefore, necessary to provide an expensive main apparatus per se.

### BRIEF SUMMARY OF THE INVENTION

It is accordingly the object of the present invention to provide a speech communication system and a communication apparatus for such speech communication system, as well as a telephone exchange apparatus, which can alleviate a processing burden and reduce an operation cost and, further, can ensure prompt and proper call reception processing.

According to an aspect of the present invention, there is provided a speech communication system comprising: a plurality of connection apparatuses to connect a circuit line and a communication network transmitting a plurality of speech packets and control packets, the circuit line being connected at least one of terminal and transmitting a corresponding speech signal, to communicate between the terminal and the communication network, respectively; and a controller which controls to forward an incoming call to another connection apparatus, when the incoming call arrives via the connection network and there exists no available circuit line, in each the connection apparatuses.

According to another aspect of the present invention, there is provided a communication apparatus for use as a plurality of connection apparatus in a speech communication system including the connection apparatuses to connect a circuit line and a communication network transmitting a plurality of speech packets and control packets, the circuit line being connected at least one of terminal and transmitting a corresponding speech signal, respectively; comprising: a controller which controls to forward an incoming call to another connection apparatus, when the incoming call arrives via the connection network and there exists no available circuit line.

According to yet another aspect of the present invention, there is provided a telephone exchange apparatus comprising: a first interface to connect a circuit line being connected at least one of terminal and transmitting a corresponding speech signal; a plurality of second interfaces to connect a communication network including a plurality of speech channels allowing a transmission of a plurality of speech packets and at least one of control channel allowing a transmission of a plurality of control packets; a exchanger which connects between the first interface and at least one of the second interfaces according to a call setting request; and a controller which controls to forward an incoming call to another second interface, when the incoming call arrives through the control channel of the connection network and there exists no available communication channels, in each the second interfaces.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, embodiments of the invention, and together with the general description given above and the detailed description of the preferred embodiments given below, serve to explain the principles of the invention.

FIG. 1 is a view showing a schematic arrangement of an IP telephone system according to a first embodiment of the present invention;

FIG. 2 is a view showing one practical management table for managing the state of a speech circuit in each interface in an IP network in FIG. 1;

FIG. 3 is a view showing one practical forward destination table in the interfaces of the IP network in FIG. 1;

FIG. 4 is a view showing another practical management table for managing the states of speech circuits in the interfaces of the IP network;

FIG. 5 shows a flowchart showing call forward processing performed by a control section in the IP interface in FIG. 1;

FIG. 6 is a view showing a schematic arrangement of an IP telephone system according to a second embodiment of the present invention;

FIG. 7 is a view showing one practical state table stored in a state data storage section in the interfaces of the IP network in FIG. 6;

FIG. 8 is a view showing a flowchart showing a state information notifying processing procedure performed by a control section in the interfaces of an IP network in FIG. 6;

FIG. 9 shows a flowchart showing a state table updating procedure performed by a control section in the interface of an IP network in FIG. 6;

FIG. 10 is a block diagram showing a schematic arrangement of an IP telephone system according to a third embodiment of the present invention;

FIG. 11 is a block diagram showing a schematic arrangement of an IP telephone system according to a fourth embodiment of the present invention;

FIG. 12 shows a flowchart showing an incoming call forwarding processing procedure performed by a control section in the interfaces of an IP network in FIG. 11; and

FIG. 13 is a block diagram showing a schematic arrangement of an IP telephone system according to a fifth embodiment of the present invention.

### DETAILED DESCRIPTION OF THE INVENTION

With reference to the drawings, the embodiments of the present invention will be described in more detail below.

### First Embodiment

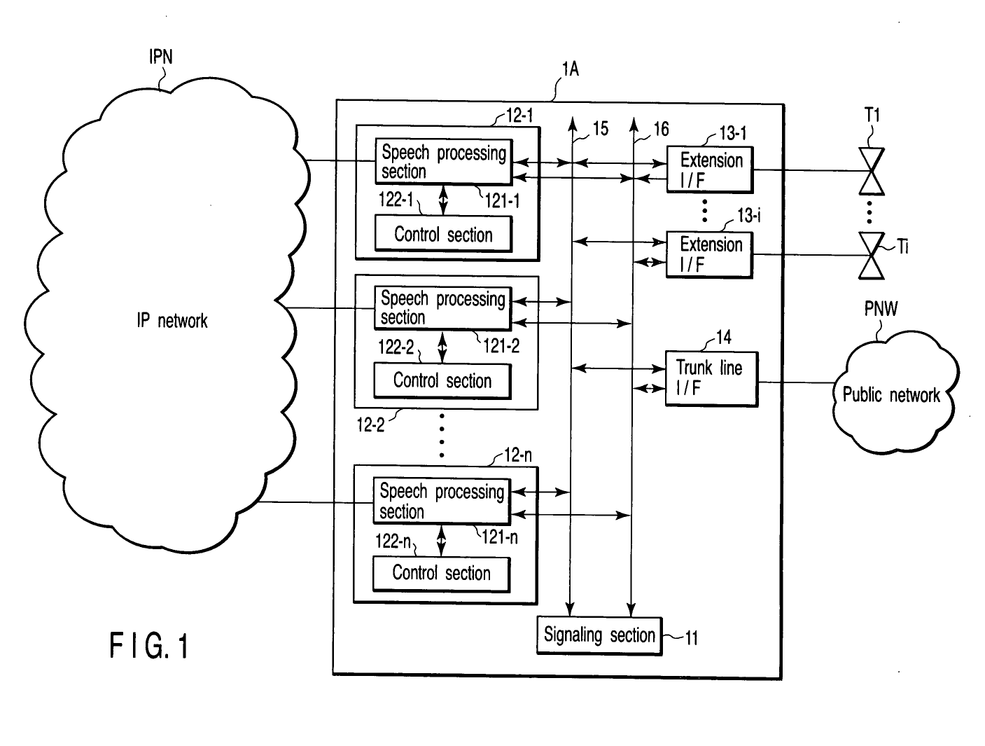

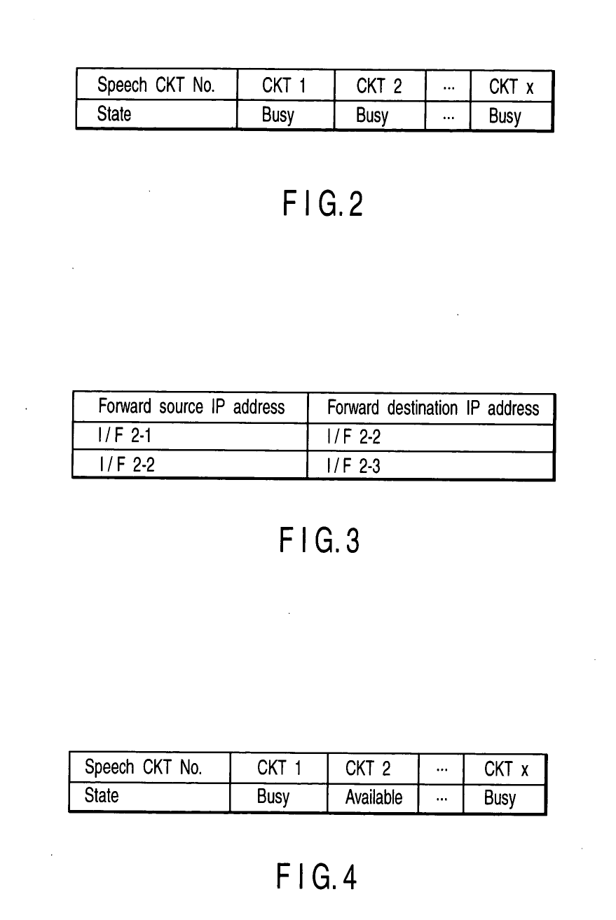

FIG. 1 shows a schematic arrangement of an IP telephone system according to the first embodiment of the present invention.

As shown in FIG. 1, the IP telephone system is so formed that, to a main apparatus 1A, an IP network IPN is arbitrarily connected and the main apparatus 1A has its extensions through which a plurality of telephone terminals T1 to Ti are arbitrarily connected. It is to be noted that the IP network IPN has, for each IPN interface, a plurality of speech channels and an equal number of control channels or at least one control channel.

The main apparatus 1A further includes a signaling section (a call controller) 11, IPN interfaces 12-1 to 12-n (hereinafter referred to as IPN IF's 12-1 to 12-n), extension interfaces 13-1 to 13-i (hereinafter referred to as extension IF13-1 to IF13-i, and a Trunk line interface 14 (hereinafter referred to as a trunk line IF14). The signaling section 11, IPN IF's 12-1 to 12n, extensions IF's 13-1 to 13-i, and trunk line IF14 are connected through a speech bus 15 and control bus 16.

The signaling section 11 allows an arbitrary exchange connection to be made between the IPN IF's 12-1 to 12-n and the extensions IF's 13-1 to 13-i, between the IPN IF's 12-1 to 12-n and the trunk line IF14, between the extension IF's 13-1 to 13-i and the trunk line IF14 and between these extensions IF's 13-1 to 13-i and allows the control of a speech signal/control signal to be made between the IPN IF's 12-1 to 12-n on one hand and extensions IF's 13-1 to 13-i and trunk line IF14 on the other.

The IP network IPN is connected, as required, to the IP IF's 12-1 to 12-n. The IP IF's 12-1 to 12-n perform an interface operation relating to the IP network IP network IPN. The IPN IF's 12-1 to 12-n allow the transfer of various control information relating to the interface operation to be made to and from the signaling section 11 through the control bus 16.

The telephone terminals T1 to Ti are connected, as required, to the extensions IF's 13-1 to 13-i. The extensions IF's 13-1 to 13-i perform an interface operation relating to the telephone terminals T1 to Ti connected thereto. Further, the extensions IF13-1 to 13-i allow the transfer of various control information relating to the above-mentioned interface operation to be made to and from the signaling section 11 through the control bus 16.

A public network PNW is connected, as required, to the trunk line IF14. The trunk line IF14 performs an interface operation relating to the public network PNW connected thereto. Further, the trunk line IF14 allows the transfer of various control information relating to the interface operation to be made to and from the signaling section 11 through the control bus 16.

Incidentally, the respective IPN IF's 12-1 to 12-n have speech processing sections 121-1 to 121-n and control sections 122-1 to 122-n, respectively. Here, an explanation will be made below by taking the speech processing section 121-1 and control section 122-1 as a representative example.

The speech processing section 121-1 has a speech circuit of, for example, 16 channels and, under control of the control section 122-1, allows a conversion to be made from a speech packet to a PCM signal or from a PCM signal to a speech packet.

The control section 122-1 allows the transmission/reception of a control signal to/from the signaling section 11 and has a management table under which the states of the speech circuits are managed. When an incoming call reaches the corresponding telephone terminal T1 from the IP network IPN, the control section 122-1 decides whether or not there exists any available speech circuit before any associated information is passed to and from the signaling section 11. If there are no available speech circuits, the incoming call is forwarded to the IPN IF12-2 (IP address: I/f2-2) based on a forward destination table shown in FIG. 3.

In the IPN IF2-2, the control section 122-2 has, as shown in FIG. 4, a management table for managing the states of the speech circuits and, upon receipt of any incoming call, decides whether or not there, exists any available speech circuit. If it is decided that the speech circuit 2 is available, then a communication link is established to the incoming call destination telephone terminal T1 with the use of the speech circuit 2.

The operation of the IP telephone system thus structured will be explained below.

Now it is assumed that any incoming call from the IP network IPN to the telephone terminal T1 arrives at the IPN IF12-1 of the main apparatus.

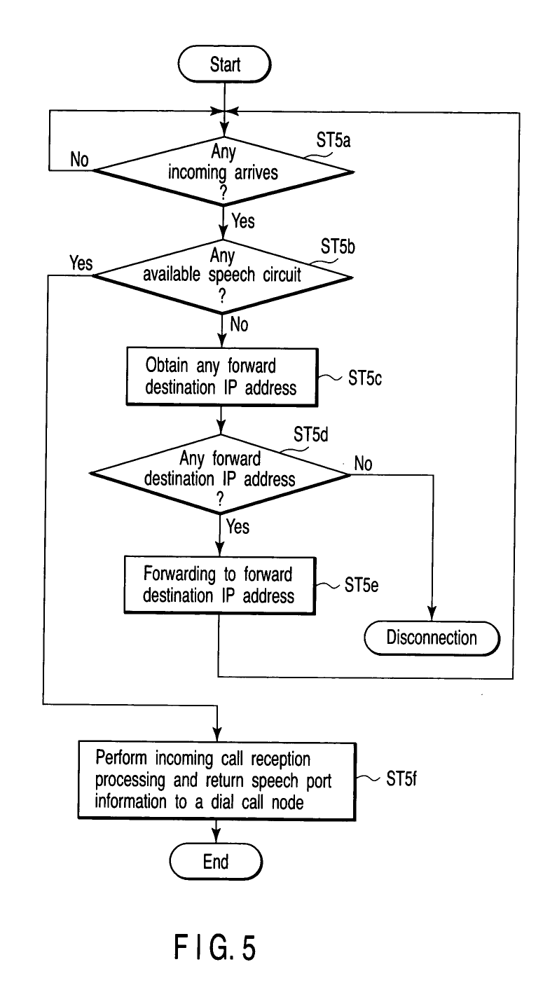

The control section 122-1 of the IPN IF12-1 performs control processing shown in FIG. 5 and monitors whether or not any incoming call arrives (step ST5a). Here, if Yes, the control section 12-1 decides whether or not there is any available speech circuit in the speech processing section 121-1 based on control table (step ST5b).

Here, since the speech circuits of the IPN IF12-1 are all busy, the control section 122-1 refers to the forward destination IP address from the forward destination table (step ST5c) and decides whether or not there is any forward destination IP address (step ST5d). Here, if there is no forward destination IP address, a notice is sent to a dial call side to the effect that re-connection be made by a different IP address and disconnection processing is done.

If, on the other hand, there exists any forward destination IP address, the control section 122-1 forwards an incoming call through the control bus 16 to the forward destination IPN IF12-1 (step ST5e).

The control section 122-2 of the IPN IF12-2, after performing the processing at step ST5a, decides whether or not there is ay available speech circuit in the speech processing section 121-2 and, when there exists any available speech circuit, the incoming call is forwarded to the signaling section 11 through the control bus 16 (step ST5f).

The signaling section 11 forwards the incoming call to the telephone terminal T1, notifying the arrival of the incoming call. When the talker on the telephone terminal T1 performs a connect operation to the incoming call, the control section 122-2 of the IPN IF12-2 sends back speech port information containing a self IP address, as a connect massage, to the caller side. Thus, a communication link using the available speech circuit is established between the telephone terminal on the caller side and the telephone terminal T1 on the called party side to allow speech communication to be made between the telephone terminal on the caller side and the telephone terminal T1.

The main apparatus 1A of the above-mentioned embodiment is so operated that, if any incoming call arrives through the control channel of the IP network IPN, whether or not there is any available speech circuits is decided by the incoming call received IPN IF12-1 and, if all the speech circuits are busy, the incoming call is forwarded to another IPN IF12-2 without passing through the signaling section 11. Until any available speech circuit is found, the incoming call forward processing is done in a repeated way.

Therefore, it is not necessary for the caller side to memorize any IP address for each of the IPN IF12-1 to 12-n in the main apparatus 1A and, by simply inputting one representative IP address, connection processing is automatically made relative to the connection destination telephone terminal T1. It is, therefore, possible to make a connection to the connection destination telephone terminal T1 for a short period of time to an extent not passing through the signaling section for processing.

On the other hand, it is possible for the incoming call receiving side to alleviate the processing burden on the signaling section 11 required for the incoming call forward processing and largely reduce the operation cost. Further, it is also possible to enhance the effective utilization rate of the speech circuit because another available speech circuit in the IPN IF12-2 can be used.

Further, according to the first embodiment, for each of the IPN IF's 12-1 to 12-n, the forward destination is fixedly decided and, even where a plurality of incoming calls involve in the same time zone, it is possible to forward these incoming calls in a parallel way and effectively effect the forwarding control of these incoming calls.

### Second Embodiment

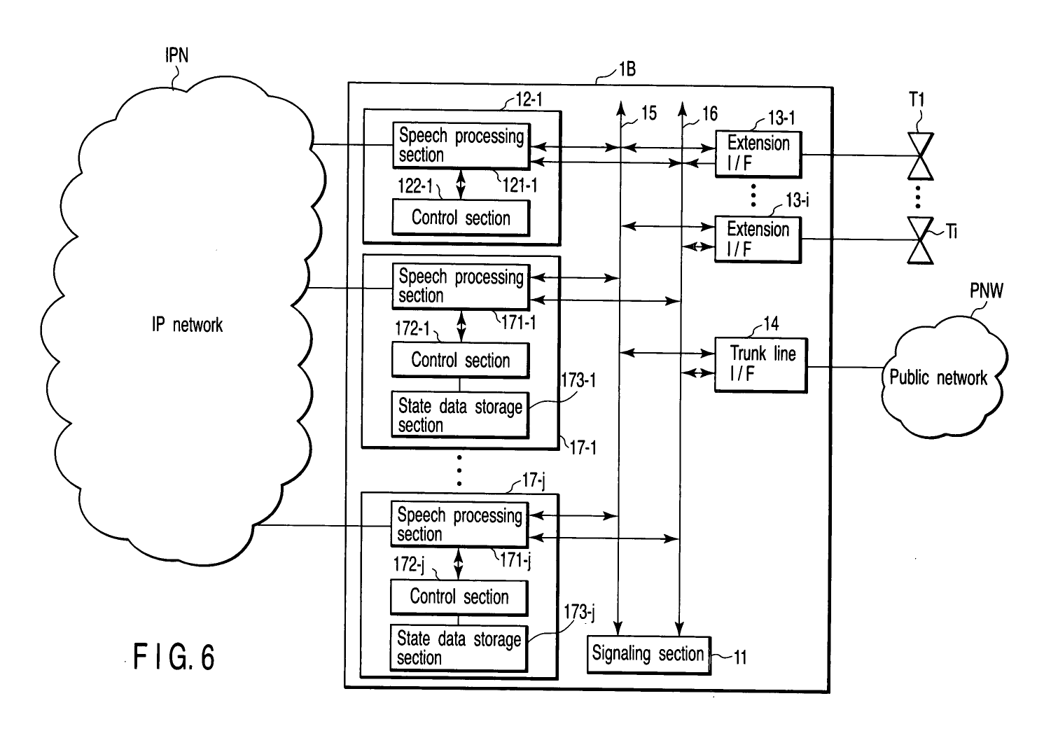

FIG. 6 is a schematic view showing an IP telephone system according to a second embodiment of the present invention. In FIG. 6, the same reference numerals are employed to designate parts or elements corresponding to these shown in FIG. 1.

A main apparatus 1B includes IP network interfaces 17-1 to 17-j (hereinafter referred to as IPN IF's 17-1 to 17-j). The IPN IF's 17-1 to 17-j include speech processing sections 171-1 to 171-j, control sections 172-1 to 172-j and state data storage sections 173-1 to 173-j (hereinafter referred to storage sections 173-1 to 173-j). Here, the IPN IF17-1 will be explained below as a representative example.

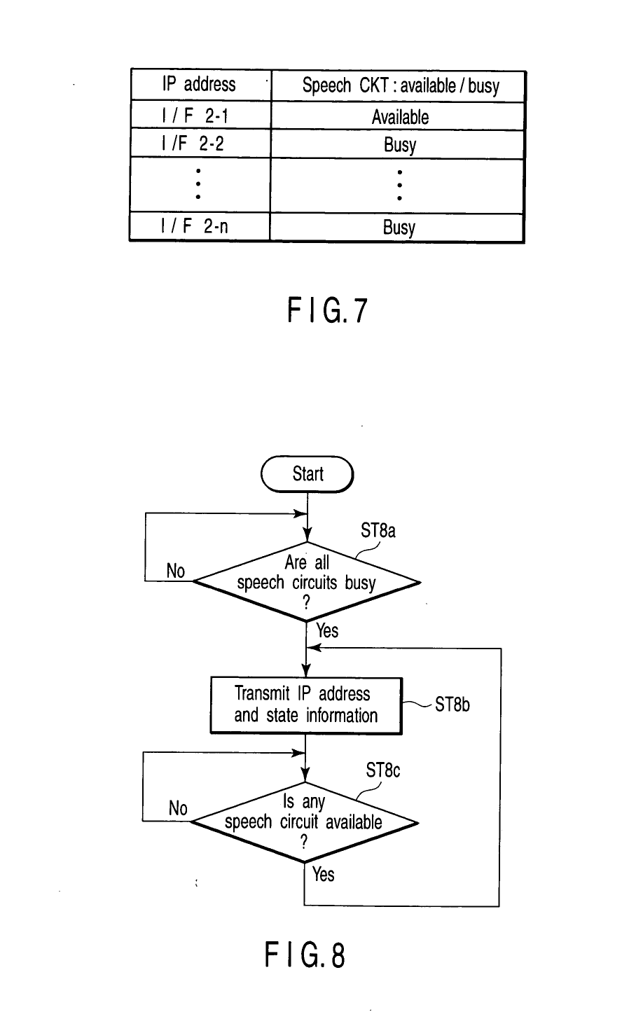

The storage section 173-1 stores, as shown in FIG. 7, a state table in which the state information item representing “available” and “busy” are matched to the IP addresses IPN IF12-1, 17-1 to 17-j.

When an incoming call arrives from the IP network IPN and the speech circuits are all busy, the control section 172-1 forwards the incoming call to the IPN IF12-1 whose speech circuit is available, that is, forwards the incoming call based on the state table stored in the storage section 173-1.

An explanation will be made below about the operation of the IP telephone system thus structured.

The control section 172-1 of the IPN IF17-1 performs control processing as shown in FIG. 8. That is, the control section 172-1 monitors whether or not all the speech circuits in the speech processing section 171-1 are busy (step ST8a) and if Yes, transmits the state information items and self IP addresses representing “busy” to the other IPN IF's 17-2 to 17-j through a control bus 16 (step ST8b). After this, the control circuit 172-1 decides whether or not any speech circuit is available (step ST8c). If Yes, control goes to step ST8b for processing.

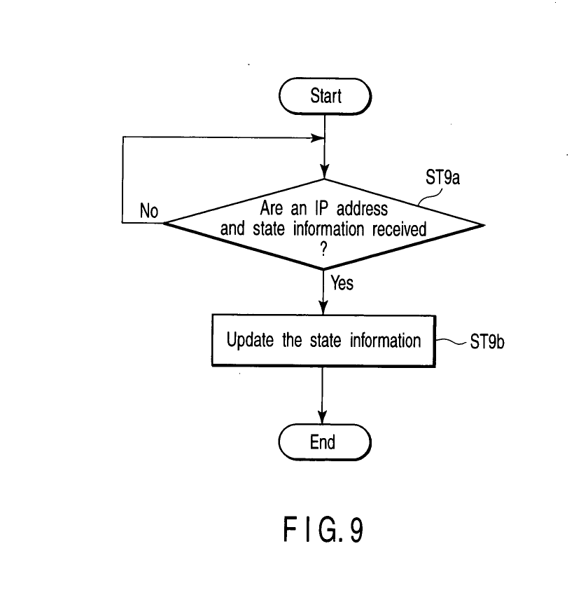

On the other hand, the control section 172-2 of the IPN IF17-2 performs control processing as shown in FIG. 9. That is, when the IP address and state information item are notified from IPN IF17-1 (step ST9a), the control section updates the state information item corresponding to the IPN IF17-1 in the state table stored in the storage section 173-1 (step ST9b).

According to the second embodiment thus structured, the storage sections 173-1 to 173-j for storing the state table are provided in the IPN IF17-1 to 17-j and, based on the state table, the control sections 172-1 to 172-j decide any available speech circuit for the respective IPN IF's 12-1 and 17-1 to 17-j. Since an incoming call is directly forwarded to, for example, the IPN IF17-2 having any available speech circuit, it is possible to perform proper and rapid connection processing in a simpler procedure.

Further, according to the second embodiment, the state table of the storage section 173-1 to 173-j can be automatically updated to the newest information at all times without any manual updating operation by the maintenance managing personnel on the main apparatus 1B.

### Third Embodiment

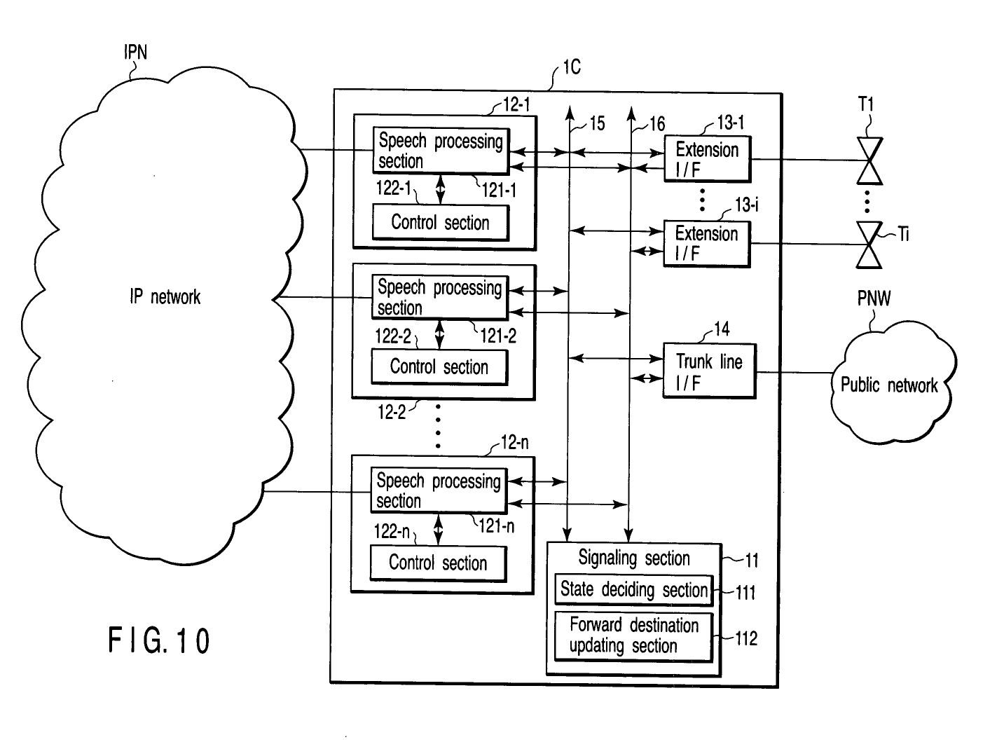

FIG. 10 is a view showing a schematic arrangement of an IP telephone system according to a third embodiment of the present invention. In FIG. 10, an explanation will be made below with the use of the same reference numerals employed to designate parts or elements corresponding to those shown in FIG. 1.

A signaling section (call controller) 11 of a main apparatus 1C includes a state deciding section 111 and a formal destination updating section 112. The state deciding section 111 decides whether or not there exists any available speech circuit in the IPN IF's 12-1 to 12-n.

Based on a result of the decision by the state deciding section 111, the forward destination updating section 112 is so operated as to, where all forward destination speech circuits in the IPN IF's 12-1 to 12-n are “engaged”, designate the IPN IF's 12-3 which has an available speech circuit as a now forward destination and update the forward designation table of the control sections 122-1 to 122-n.

According to the above-mentioned third embodiment, the forward destination tables of the respective control sections 122-1 to 122-n are updated based on the in-use state of the speech circuit in the IPN IF's 12-1 to 12-n controlled by the signaling section 11. Since, therefore, any call is not forwarded to all busy IPN IF's 12-1 to 12-n from the outset and it is possible to make rapid and proper connection processing an hence to alleviate the processing burden of the respective IPN IF's 12-1 to 12-n.

### Fourth Embodiment

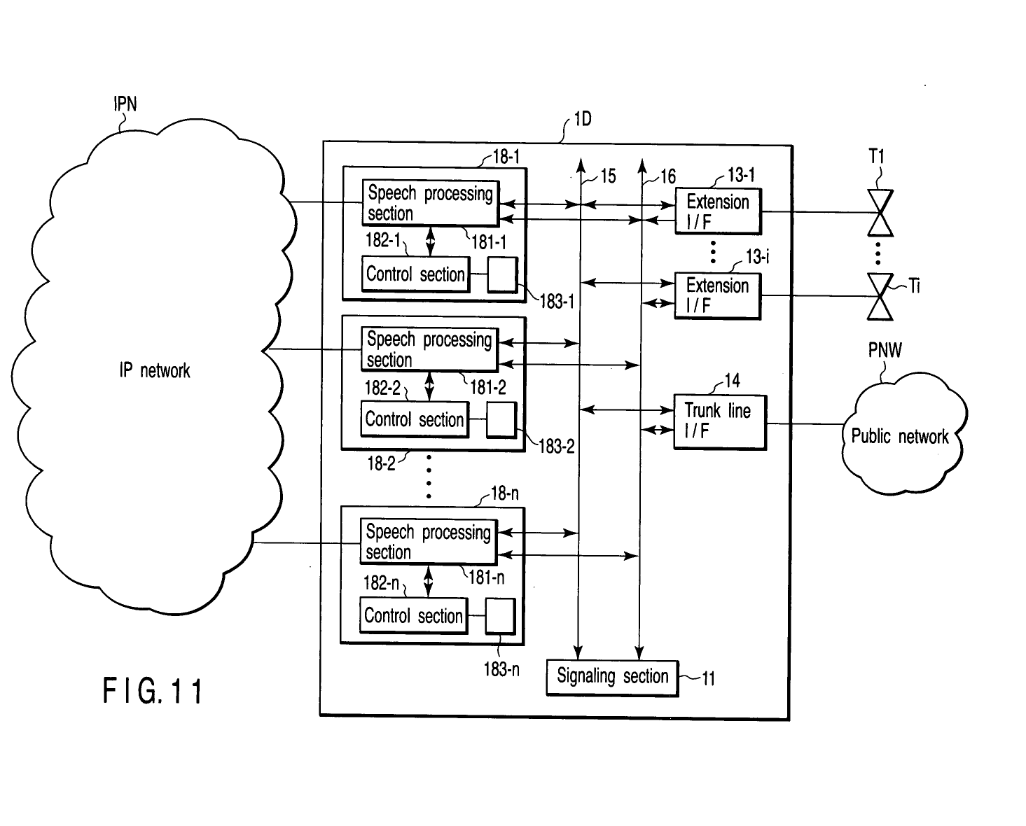

FIG. 11 is a view showing a schematic arrangement of an IP telephone system according to a fourth embodiment of the present invention. In FIG. 11, the same reference numerals are employed to designate parts or elements corresponding to those shown in FIG. 1.

A main apparatus ID includes an IPN interfaces 18-1 to 18-n (hereinafter referred to as IPN IF's 18-1 to 18-n). The IPN IF's 18-1 to 18-n include speech processing sections 181-1 to 181-n, control sections 182-1 to 182-n and forward repeated number adding sections 183-1 to 183-n (hereinafter referred to as adding sections 183-1 to 183-n). Here, an explanation of it will be made below using IPN IF18-1 as a representative example.

The adding section 183-1 adds “1” as forward repeated number information to an incoming call to be forwarded to another IPN IF182-2. At the time of receiving the incoming call, the control section 182-1 decides whether or not the forward repeated number information is above a predetermined value and, if so, the forwarding of the incoming call is stopped.

The operation of the IP telephone system thus structured will be explained below.

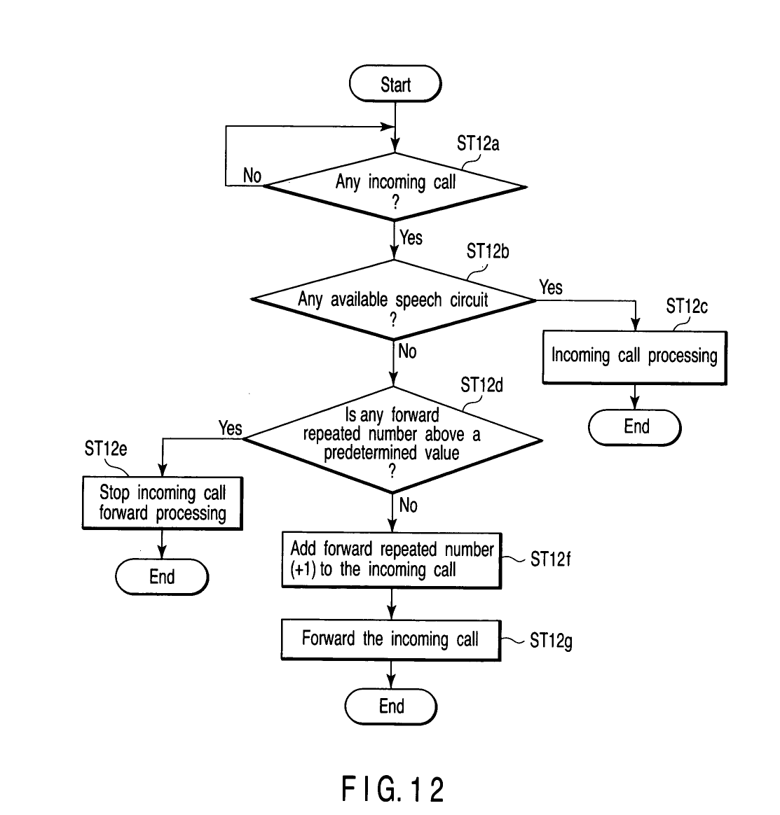

The control section 182-1 of the IPN IF18-1 performs control processing as shown in FIG. 12. That is, the control section monitors whether or not any incoming call is received (step ST12a) and, if Yes, decides whether or not there exists any available speech circuit (step ST12b). If Yes, the control section performs incoming call processing with the use of the available circuit (step ST12c).

If No, the control section 182-1 decides whether or not any forward repeated number information is added to the incoming call and, if the forward repeated number information is added to the incoming call, decides whether or not the forward number is above a predetermined value (step ST12d). If Yes, the control section 182-1 stops the incoming call forward processing and notifies the caller to the effect that re-connect operation will be made (step ST12e).

If, on the other hand, the forward repeated number is less than the predetermined value (No), the control section 182-1 forwards the incoming call to the adding section 183-1 where the forward repeated number information (+1) is added to the incoming call (step ST12f). The resultant incoming call is forwarded to another IPN 18-2 through the control bus 16 (step ST12g). Incidentally, the forward repeated number information may be forwarded, by way of the IP network IPN, with a control message (SETUP) added thereto.

In the above-mentioned fourth embodiment, the adding sections 183-1 to 183-n are provided in the IPN IF's 18-1 to 18-n and, where any control sections 182-1 to 182-n decide that the forward repeated number added to the incoming call is above the predetermined value, the control section notifies the caller side to make re-connection again, so that it is possible to automatically step the forward processing on an elapsed-time old incoming call.

Thus, the caller side grasps the rejection of his or her call as an incoming call to the destination side and can make any prompt and proper re-connection operation, etc. Further, the main apparatus ID on the incoming call side can make the next incoming call processing promptly.

### Fifth Embodiment

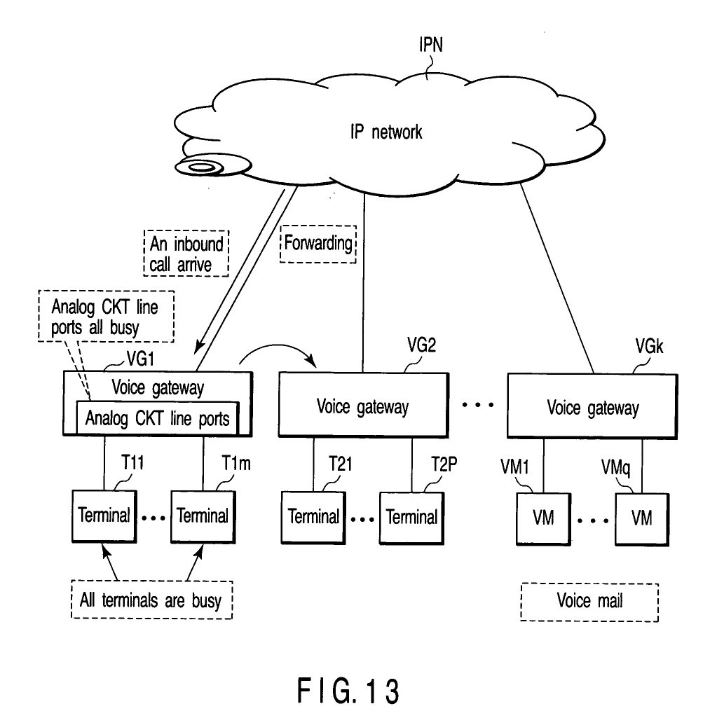

FIG. 13 is a view showing a schematic arrangement of an IP telephone system according to a fifth embodiment of the present invention. In FIG. 13, VG1 to VGk represent voice gateways; T11 to T1m and T21 to T2P, terminal devices; and VM1 to VMq, voice mail devices. The voice gateways VG1 to VGk are connected through an IP network IPN. Further, the terminal devices T11 to T1m and T21 to T2P, and voice mail devices VM1 to VMq, respectively, constitute extension groups.

The voice gateway VG1 makes a connection between the IP network IPN and the terminal devices T11 to T1m and has communication protocol and signal format conversion functions between the IP network IPN and the terminals T11 to T1m.

The voice gateway VG2 makes a connection between the IP network IPN and the terminal devices T21 to T2P and has communication protocol and signal format conversion functions between the IP network IPN and the terminal devices T21 to T2P.

The voice gateway VGk makes a connection between the IP network IPN and the voice mail devices VM1 to VMq and has the communication protocol and signal format conversion functions between the IP network IPN and the voice mail devices VM1 to VMq.

Further, the voice gateway VG1 has a management table for managing the state of an analog circuit line port and has the function of deciding whether or not there exists any available analog circuit line port when an incoming call reaches a destination terminal device T11 from the IP network IPN. The voice gateway VG1 has the function of forwarding an incoming call to the voice gateway VG2 by way of the IP network IPN if, of all the analog circuit line ports, none of them is available.

The voice gateway VG2 has a management table for managing the states of the analog circuit line ports and decides whether or not there exist any available analog circuit line port when an incoming call is received. This gateway creates, when there exists no available analog circuit line port, a communication link relative to, for example, the terminal device T21 with the use of the analog circuit port.

According to the above-mentioned fifth embodiment, it is not necessary to provide any gate keeper for managing the operation states of the voice gateways VG1 to VGk and, when any incoming call to, for example, the terminal device T11 arrives from the IP network IPN and all the analog circuit line parts in the voice gateway VG1 are “engaged”, the incoming call is forwarded directly to the voice gateway VG2 or voice gate VGk. It is, therefore, possible to largely reduce the cost of the system as a whole.

### Other Embodiments

The present invention is not restricted to the above-mentioned embodiments. Although, in the above-mentioned fifth embodiment for example, an explanation has been made in connection with forwarding an incoming call of a destination to the terminal device T11 onto the voice gateway VG2 when there is no available analog circuit line port of the voice gateway VG1, the present invention is not restricted thereto. By a forward destination table, for example, a forward destination may be fixedly allocated to the voice gateway VGk.

In the above-mentioned fifth embodiment, a state data storage section is provided, as in the case of the above-mentioned second embodiment, for storage-managing the in-use states of the analog circuit line ports in the voice gateways VG1 to VGk and has the function to forward an incoming call based on its storage contents.

In the above-mentioned fifth embodiment, a forward repeated number adding function, as well as a function to stop an incoming call forward processing in the case where the forward number of times reaches a predetermined value, may be provided as in the case of the fourth embodiment.

Although, in the above-mentioned first embodiment, the forward destination table with a forward source and forward destination set in a one-to-one corresponding relation has been explained as being provided in the respective IPN IF's 12-1 to 12-n, it may be considered that, depending upon the forward source, a forward destination table is provided in a way to have no forward destination. By doing so, a final forward interface is handled and it is possible to restrict the forwarding number of times.

With respect to the kind of system and its structure, the structure of the main apparatus, the kind of terminal device such as a telephone terminal, the kind of communication apparatus such as a voice gateway and its structure, the functional structure of each interface, the incoming call forward processing procedure, and so on, various changes and modifications can be made without departing from the essence of the present invention.

Additional advantages an modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A speech communication system comprising:
a plurality of connection apparatuses to connect a circuit line and a communication network transmitting a plurality of speech packets and control packets, the circuit line being connected at least one of terminal and transmitting a corresponding speech signal, to communicate between the terminal and the communication network, respectively; and
a controller which controls to forward an incoming call to another connection apparatus, when the incoming call arrives via the connection network and there exists no available circuit line, in each the connection apparatuses.

2. A speech communication system according to claim 1, wherein at least one of the connection apparatuses further comprises a memory which stores a state table for matching state information representing at least one of an available circuit line and a busy circuit line to associated identification information representing connection apparatus,
and wherein the controller forwards the incoming call to another connection apparatus including available circuit line based on the state table, when the incoming call arrives and there exists no available circuit line.

3. A speech communication system according to claim 2, wherein at least one of the connection apparatuses further comprises,
a notifying circuit to notify the state information and self identification information to another connection device, when the state of the circuit line is varied, and
an updating circuit to update the state information of an associated connection apparatus on the state table, when the state information and identification information are notified from another connection apparatus.

4. A speech communication system according to claim 1, wherein at least one of the connection apparatuses further comprises,
a memory which stores a forward destination table in which forward information representing an incoming call forward destination is matched to identification information representing connection apparatus,
and wherein the controller forwards the incoming call to another connection apparatus based on the forward destination table, when an incoming call arrives from the communication network and there exists no available circuit line.

5. A speech communication system according to claim 1, wherein the controller comprises,
an adder which adds at least one of forward repeated number information to the incoming call to be forwarded to another connection apparatus and,
a restricting circuit to inhibit the forwarding of the incoming call by deciding the forward repeated number information is above a predetermined value, when the incoming call is received.

6. A communication apparatus for use as a plurality of connection apparatus in a speech communication system including the connection apparatuses to connect a circuit line and a communication network transmitting a plurality of speech packets and control packets, the circuit line being connected at least one of terminal and transmitting a corresponding speech signal, respectively; comprising:
a controller which controls to forward an incoming call to another connection apparatus, when the incoming call arrives via the connection network and there exists no available circuit line.

7. A communication apparatus according to claim 6, further comprises a memory which stores a state table for matching state information representing at least one of an available circuit line and a busy circuit line to associated identification information representing connection apparatus,
and wherein the controller forwards the incoming call to another connection apparatus including available circuit line based on the state table, when the incoming call arrives and there exists no available circuit line.

8. A communication apparatus according to claim 7, further comprises,
a notifying circuit to notify the state information and self identification information to another connection device, when the state of the circuit line is varied, and
an updating circuit to update the state information of an associated connection apparatus on the state table, when the state information and identification information are notified from another connection apparatus.

9. A communication apparatus according to claim 6, further comprises,
a memory which stores a forward destination table in which forward information representing an incoming call forward destination is matched to identification information representing connection apparatus,
and wherein the controller forwards the incoming call to another connection apparatus based on the forward destination table, when an incoming call arrives from the communication network and there exists no available circuit line.

10. A communication apparatus according to claim 6, wherein the controller comprises,
an adder which adds at least one of forward repeated number information to the incoming call to be forwarded to another connection apparatus and,
a restricting circuit to inhibit the forwarding of the incoming call by deciding the forward repeated number information is above a predetermined value, when the incoming call is received.

11. A telephone exchange apparatus comprising:
a first interface to connect a circuit line being connected at least one of terminal and transmitting a corresponding speech signal;
a plurality of second interfaces to connect a communication network including a plurality of speech channels allowing a transmission of a plurality of speech packets and at least one of control channel allowing a transmission of a plurality of control packets;
a exchanger which connects between the first interface and at least one of the second interfaces according to a call setting request; and
a controller which controls to forward an incoming call to another second interface, when the incoming call arrives through the control channel of the connection network and there exists no available communication channels, in each the second interfaces.

12. A telephone exchange apparatus according to claim 11, wherein at least one of the second interfaces further comprises a memory which stores a state table for matching state information representing at least one of an available communication channel and a busy communication channel to associated identification information representing second interface,
and wherein the controller forwards the incoming call to another second interface including available communication channel based on the state table, when the incoming call arrives and there exists no available communication channels.

13. A telephone exchange apparatus according to claim 12, wherein at least one of the second interfaces further comprises,
a notifying circuit to notify the state information and self identification information to another second interface, when the state of the communication channel is varied, and
an updating circuit to update the state information of the corresponding second interface on the state table, when the state information and identification information are notified from another second interface.

14. A telephone exchange apparatus according to claim 11, wherein at least one of the second interfaces further comprises,
a memory which stores a forward destination table in which forward information representing an incoming call forward destination is matched to identification information representing second interface,
and wherein the controller forwards the incoming call to another second interface based on the forward destination table, when an incoming call arrives from the communication network and there exists no available communication channel.

15. A telephone exchange apparatus according to claim 14, further comprising:
a deciding circuit to decide whether or not any communication cannel is available in the respective second interfaces, to generate a decision signal; and
an updating circuit to update the forward destination information in the forward destination table to forward destination information of an available communication channel based on the decision signal.

16. A telephone exchange apparatus according to claim 11, wherein the controller further comprises,
an adder which adds at least one of forward repeated number information to the incoming call to be forwarded to another second interface; and
a restricting circuit to inhibit the forwarding of the incoming call by deciding the forward repeated number information is above a predetermined value, when the incoming call is received.
